(19) United States
(12) Patent Application Publication
(10) Pub. No.: US 2026/0057376 A1
(43) Pub. Date: Feb. 26, 2026

(54) SYSTEMS AND METHODS FOR CRYPTOCURRENCY ADMINISTRATION

(71) Applicant: Minty Networks, LLC, Cumming, GA (US)

(72) Inventors: Albert Einstein Renshaw, Ph.D., Cumming, GA (US); Connor Matthew Duggan, Victoria (CA)

(21) Appl. No.: 19/373,879

(22) Filed: Oct. 30, 2025

Related U.S. Application Data
(62) Division of application No. 18/052,335, filed on Nov. 3, 2022.
(60) Provisional application No. 63/275,117, filed on Nov. 3, 2021.

(51) Int. Cl. G06Q 20/36; G06Q 20/32; G06Q 20/38; G06Q 20/40

(52) U.S. Cl. CPC G06Q 20/3678; G06Q 20/3223; G06Q 20/3255; G06Q 20/3829; G06Q 20/4012

(57) ABSTRACT

Technologies are described herein for the administration of cryptocurrency. A currency transfer server is used to support the administration of a user wallet using a device capable of communicating via a cellular network. A coin transfer application receives instructions on how much cryptocurrency to send and the cellular number to which the cryptocurrency is to be sent. A temporary wallet is instantiated to receive the transfer, whereby the recipient receives a withdrawal code using a messaging application from the sender. Once received, the recipient can transfer the cryptocurrency from the temporary wallet to the recipient’s wallet or use the temporary wallet as the permanent wallet.

### CROSS REFERENCE TO RELATED APPLICATIONS

This application is a divisional application of U.S. Patent No. 18/052,335, filed November 3, 2022, which claims the benefit of U.S. Provisional Application no. 63/275,117 filed November 3, 2021, entitled “Systems and methods for Cryptocurrency Administration,”, which are incorporated herein by reference in their entirety.

### BACKGROUND

Transferring cryptocurrency is often a complex transaction involving multiple “wallets” that are used to store and transfer cryptocurrency from one user to another. The use of authentication methods can create barriers to use because of the complexity often associated with those methods (including the use of passwords or passkeys to access wallets).

Examples of the present disclosure are directed to overcoming deficiencies of such systems.

### BRIEF DESCRIPTION OF DRAWINGS

FIG. 1 illustrates a cryptocurrency transfer system, in accordance with one or more examples of the presently disclosed subject matter.

FIG. 2 is a method for sending and receiving cryptocurrency, in accordance with one or more examples of the presently disclosed subject matter.

FIG. 3 depicts a component level view of the user device for use with the systems and methods described herein, in accordance with various examples of the presently disclosed subject matter.

### DETAILED DESCRIPTION

Examples of the presently disclosed subject matter use a cellular device to decentralize the transfer of an amount of cryptocurrency from an account of a sending user to an account of the receiving user. In some examples described herein, an application on a user device configures and enables the user device to act as a cryptocurrency server for cryptocurrency wallet administration. The device is integrated with a currency transfer server that is configured to support the local cryptocurrency server for cryptocurrency wallet administration on the user device. As used herein, “cryptocurrency” describes a digital currency in which transactions are verified and records maintained by a decentralized system using cryptography, rather than by a centralized authority. In some examples, cryptocurrencies use blockchain technology to achieve decentralization, transparency, and immutability.

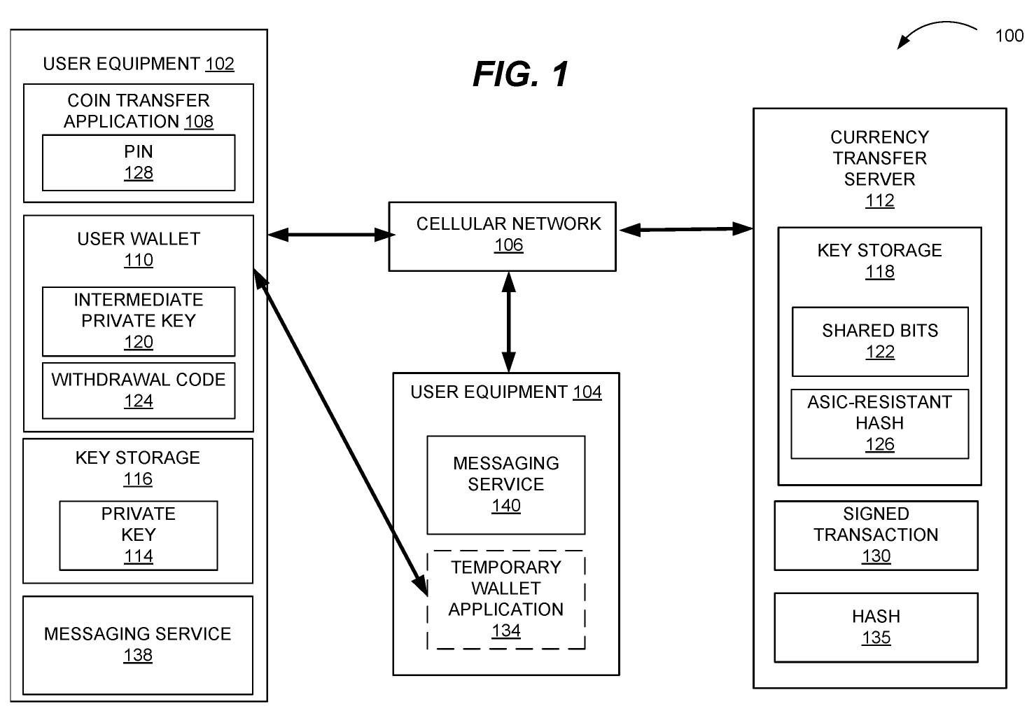

FIG. 1 illustrates a cryptocurrency transfer system 100. Illustrated in FIG. 1 is a user equipment (UE) 102 and a user equipment (UE) 104. Examples of the UE 102 or 104 can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a cellular network, such as the cellular network 106. In general, the cellular network 106 can be implemented as a variety of technologies to provide wired and/or wireless access to a network, as discussed herein. In some instances, the cellular network 106 can include a 3GPP Radio Access Network (“RAN”), such a GSM/EDGE RAN (GERAN), a Universal Terrestrial RAN (UTRAN), or an evolved UTRAN (E-UTRAN), or alternatively, a “non-3GPP” RAN, such as a Wi-Fi RAN, or another type of wireless local area network (WLAN) that is based on the IEEE 802.11 standards. Further, the cellular network 106 can include any number and type of transceivers and/or base stations representing any number and type of macrocells, microcells, picocells, or femtocells, for example, with any type or amount of overlapping coverage or mutually exclusive coverage.

To provide for the transfer of cryptocurrency, the UE 102 includes a coin transfer application 108. The coin transfer application 108 facilitates various operations for transferring cryptocurrency stored in a user wallet 110 as a monetary deposit to a user of the UE 104. As used herein, a “wallet” is used to store one or more keys that, when entered into an access portal, allows a user to manage their cryptocurrency balances. Although not limited to any particular implementation of a wallet, in some examples, the user wallet 110 reads a public ledger to show balances in the user’s cryptocurrency wallet address(e)s and also holds the private keys that enables a user to make transactions.

When transferring money, a user (not pictured) of the UE 102 selects for use the coin transfer application 108. The coin transfer application 108 instantiates the user wallet 110, making the user wallet 110. To make the user wallet 110 available for use, the user wallet 110 contacts a currency transfer server 112 via the cellular network 106. The currency transfer server 112 receives a communication from the user wallet 110 requesting any keys that may be needed by the user to facilitate a transfer of cryptocurrency. In some examples, private key(s) 114 used to access the wallet are stored in a key storage 116 located on the UE 102. In other examples, the private key 114 may be stored in a key storage 118 of the currency transfer server 112, or both. In some examples, the private key 114 is generated by the UE 102.

In some examples, the private key 114 (or other private keys described herein) may be recoverable. A private key, typically for a cryptocurrency wallet, is generated by the UE 102 using an algorithm consisting of various components and hashing algorithms. This private key can later be regenerated using some of the components, via brute forcing, in a way such that if enough of the components are known it is feasible to brute force, but if not enough of the components are known, it is not feasible to brute force. As used herein, “brute forcing” means a code regeneration method whereby a series of attempts are made to decode a number or password in a “trial and error” process. An alpha-numeric-symbolic PIN is generated, typically 9 characters long. This PIN is decoded into "Memorized Bits," and is memorized or written down by the user. A random large number of bits are generated and stored on a server, such as the currency transfer server 112, with an access level controlled by two-factor or two-step authentication measures associated with the user. These are the "Shared Bits. A random smaller number of bits are generated and deleted. These are the "Deleted Bits." At the time of the private key's generation, all of these bit segments are known. The algorithm then creates another section of bits by applying an ASIC-resistant/GPU-resistant slow-hash (e.g., ARGON2) to bits which are made from the Memorized Bits and a varying amount of the Shared Bits. This hash is performed using the Shared Bits as a 'salt'.

The resulting bits from this hash are then concatenated to the Memorized Bits, the Shared Bits, and the Deleted Bits. This concatenation is then hashed using a fast-hash (e.g. SHA256). The output of this hash is the private key. Because of this structure, if a hacker had access to only the Shared Bits, they could not reasonably brute force the rest of the bits used in hashing out the Private Key, because the ASIC-resistant hash is too slow. Whereas, an authorized user who does also know the PIN is able to regenerate the private key in a reasonable time, as the slow part of the process is solved fast for them since their PIN, therefor the Memorized Bits, will be correct.

Depending on how much security is needed, some of the Deleted Bits may be stored locally as "Local Bits" to speed up the slow-hash time for users operating on a device which has previously had access to the key. These "Local Bits" can be encoded into an alpha-numeric-symbolic "Transfer Code" similar to how the Memorized bits can be encoded into an alpha-numeric-symbolic "PIN." This Transfer Code can then be entered on new devices by the user, who has access to both devices, to thereby 'transfer' some of the entropy of the Deleted Bits, thus speeding up the initial brute force process. Once this process is successful, the transfer code is decoded and stored as Local Bits on the new device to speed up future brute forcing. The Private Key is never stored. The server operators do not have enough info the recreate a user's private key. All bits are generated using cryptographically-secure algorithms. The user's PIN is created for them by encoding the Memorized Bits, but it could be provided by the user, in the form of any data entry not just a PIN, and decoded into "Memorized Bits," assuming the user's data source were securely generating sufficiently random data.

When the private key of a user's wallet is known, typically in RAM, transactions can be signed on behalf of the user. Transactions are signed to drain the wallet's balance via a transfer to a trusted third-party's master wallet. These transactions are not broadcast to the blockchain network for recordation of the transaction onto the blockchain but are instead held by the trusted third-party for broadcasting at a later date. These signed but not broadcast transactions can be called "Presigned Transactions," that is, transactions that were signed ahead of time.

Depending on the blockchain network, various variables in a transaction may be subject to change. In Bitcoin, only transactions with valid unspent transaction outputs (UTXOs) can be broadcast. If a user later makes a transaction, thus using up one or more of the UTXOs, the presigned transaction will no longer be valid since not all UTXOs are valid; because of this, additional transactions are presigned using various combinations of the UTXOs or even just single UTXOs so that as some UTXOs are used in the future. The other UTXOs are still able to be drained from various of the presigned transactions. In Ethereum, every wallet has a nonce, and if the nonce increases from future transactions occurring, presigned transactions would no longer have the current nonce, and therefore would be invalid; because of this, additional transactions with many increasing nonces are signed in advanced so that at the time of account recovery, if nonce had increased since the time of presigning, a valid presigned transaction will still exist with the correct current nonce.

For example, in Ethereum, the wallet balance can change as transactions are made, so various amounts are presigned as well, so that at least partial recovery of funds may occur if balance lowered from time of presigning, though this is optional since additional funds could simply be sent to the address, after the fact, to make the presigned transaction's value within the balance's range. In many networks, including Bitcoin and Ethereum, network fees are subject to change; because of this, multiple transactions are signed with multiple historical network fees and future estimated network fees, so that if network fees change drastically, a presigned transaction will exist with a qualifying level of network fees.

These presigned transactions are asymmetrically encrypted using a public key provided by the trusted third-party and are then sent to the third-party's server. If the third-party's servers were compromised AND the third-party's private encryption key were compromised, the worst a hacker could do is drain the user's wallet into the third-party's wallet. The hacker could not access the funds. At a time when the wallet owner should lose their private key, they can approach the trusted third-party who can then decrypt the presigned transactions and broadcast one or more of them to retroactively drain that user's wallet into their own wallet then issue the funds back to a new wallet, now actively owned by that user. For example, the following operations may be used: signing a transaction to generate a signed transaction that transfers all funds in the wallet to a trusted third-party storage wallet, wherein the transaction is not broadcast to a blockchain; asymmetrically encrypting and storing the signed transaction on the trusted third-party server; receiving a notice that access to the wallet has been lost due to a loss of a private key used to access the wallet; confirming, by the trusted third-party, the identity of the owner of the wallet; decrypting the signed transaction; broadcasting the decrypted signed transaction to a mining node; and removing funds from the wallet and returning the funds to the owner.

In some examples, transactions involving the user wallet 110 or a temporary wallet application 134 may be optimized to reduce the cost associated with transactions. The temporary wallet application 134 is an application accessible or executable on a user equipment that provides for access to a temporary wallet. In-app purchases: The developer integrates our framework into their project. The developer presents the option to a user to buy various in app products at different prices, our API tells them what exchange rates to display for items based on pricing info provided by the developer. The user selects an item, they are taken to a screen we generate which tells them how much of a cryptocurrency to send and where to send it. This info is also encoded in a QR code which can be used by the user. Once the user makes the transaction, it is detected by our servers and our API alerts the app which alerts the developer who can then release or semi-release the purchased item depending on their preference of event handling.

Events include, but are not limited to, Transaction Detected (in mempool), Transaction Likely To Be Valid, Transaction Mined, Transaction Confirmed (which can be further queried to see how many confirmation blocks have passed), Transaction Failed, and Transaction Unconfirmed (which may only occur on certain types of crypto networks depending on their internal structure). In some examples, the private key of any given wallet can be derived from the one generation-key. When a user of an app goes to make a transaction, the coin transfer application 108 can send an application programming interface (API) a user ID (UID) and return one of millions of addresses for the user to use. This address is then reserved for only that user for a fixed time. The lowest nonce address that's available is usually the one used so that funds accumulate front-heavy in the list of wallets.

Because of the UID/Address exchange, the API can correlate a cryptocurrency transaction to a specific user since the address to which the transaction came in was reserved only for that user's UID during that time slot. This is done without the user having to provide any identifying info in the cryptocurrency transaction itself, or any data at all for that matter. The transaction is marked in systems as belonging to the developer of the app. The developers running balance will increase as more transactions come into various addresses their users used. Whenever an address's balance reaches a certain threshold, an air-gapped system sign a transaction which can be broadcast to drain that wallet to a central master wallet. Whenever a developer's balance reaches a certain threshold, they can request a "payout" (or it may be initiated on their behalf). This payout will be funded in one transaction from the central master wallet, rather than every address their user base interacted with. Because this is all done in one transaction, a cost savings can be realized on potential withdrawal fees.

Returning to FIG. 1, when ready to transfer cryptocurrency from the user wallet 110 for use by a user (not pictured) of the UE 104 using a cellular phone number of the UE 104, an intermediate private key 120 is generated. The intermediate private key 120 includes various components. The intermediate private key 120 includes shared bits 122 which are stored on the currency transfer server 112. The intermediate private key 120 further includes random bits which are autogenerated and not stored, as the random bits are used during the process of private key generation (or brute forcing). Further, the intermediate private key 120 further includes a withdraw code that is used by the receiver of the cryptocurrency. In some examples, the withdraw code is stored on the UE 102 as part of the intermediate private key 120. In some examples, storing the withdrawal code 124 on the UE 102 allows the user to resend the withdrawal code 124 to a recipient if the recipient loses the withdrawal code 124. In some further examples, the withdrawal code 124 can also be stored on the currency transfer server 112. For example, the withdrawal code 124 can be padded then encrypted with a secret key derived from a sender’s private key.

The coin transfer application 108 further causes the generation of an ASIC-resistant hash 126 using an ASIC-resistant algorithm. When a personal identification number (PIN) 128 is known, SHA256 becomes the dominant time-factor. As used herein, “SHA 256” is a part of the SHA 2 family of algorithms, where SHA stands for Secure Hash Algorithm. If the PIN 128 is not known, ARGON2 becomes the dominant time-factor. As used herein, “Argon2” Argon2 is cryptographic hashing algorithm. It should be noted, however, that the presently disclosed subject matter is not limited to any particular hashing algorithm.

Once the ASIC-resistant hash 126 is generated, a signed transaction ("Raw Txn") 130 is generated and transmitted from the currency transfer server 112 to the UE 102. The signed transaction 130 is used to send the desired amount of cryptocurrency from the user wallet 110 to a public address associated with the generated private key, that is, to an intermediate or temporary wallet accessible by the temporary wallet application 134. The size of the three-bit sections (the shared bits 122, the random bits, and the withdrawal code 124) can be dependent on the value of the transaction. For example, for larger transactions, more bits may be allocated to random bits, and more bits allocated to the Withdrawal Code. A hash 135 of the private key 114 is generated and stored on the currency transfer server 112 so that the private key 114 can be brute-forced and checked against the hash 135 to confirm a match. It should be noted, however, that this may also be optional as the check could be performed against the Intermediary Wallets public address, which is known, and can be derived from a proper Private Key brute force attempt.

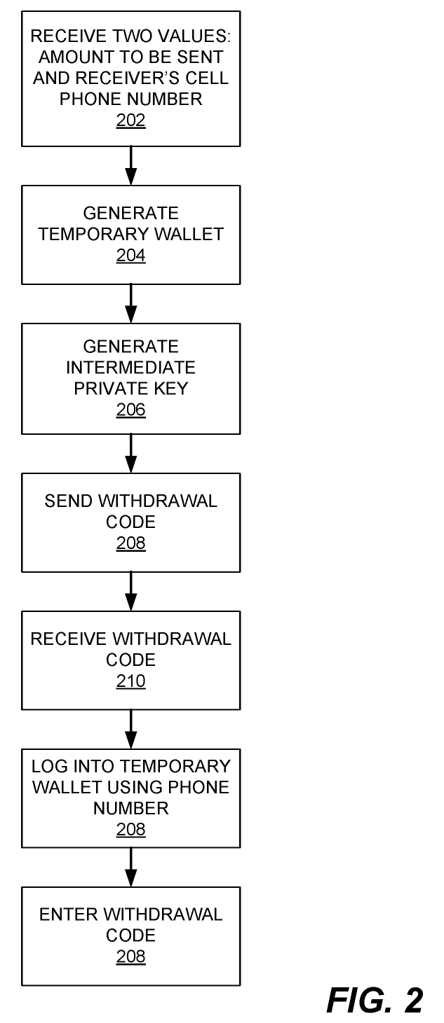

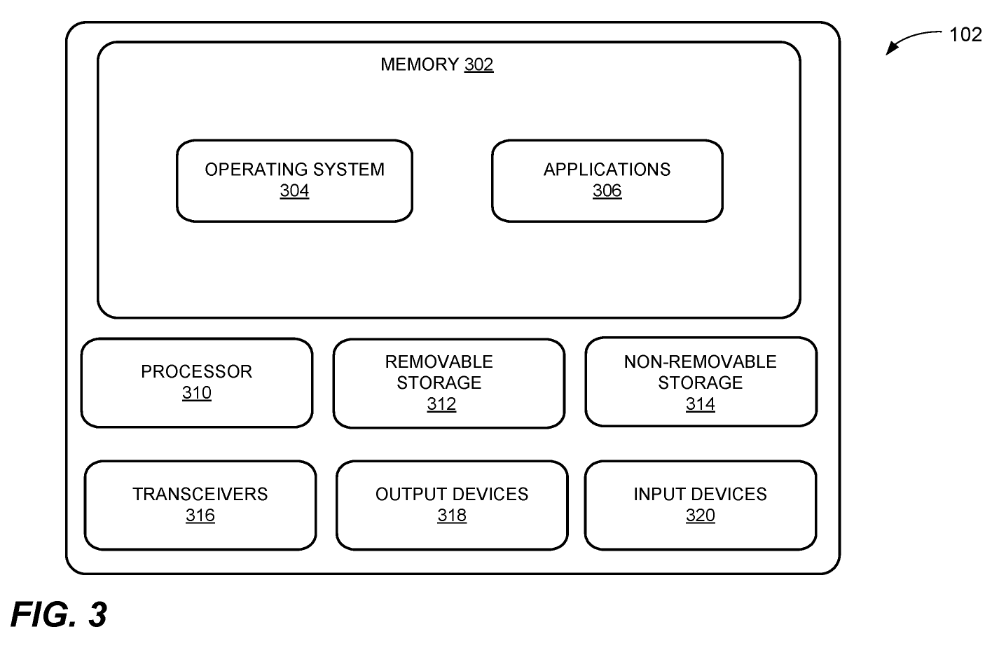

A messaging service 138 is used to transmit the withdrawal code 124 to the messaging service 140 on the UE 104. The temporary wallet accessible by the temporary wallet application 134 is accessed and, upon entering the withdrawal code, the temporary wallet accessible by the temporary wallet application 134 is established for the recipient using the UE 104. In some examples, the withdrawal code 124 can further include a request for a photograph of the user using the UE 104 as part of the verification and activation of the withdrawal code 124. Once the UE 102 receives the photograph from the UE 104 and is verified (either by a user or other service), the withdrawal code 124 may be activated for use. In still further examples, the withdrawal code 124 can further include a request for a picture, sound, and/or video available to be transmitted by the UE 104 as part of the verification and activation of the withdrawal code 124. Once the UE 102 receives the picture, sound, and/or video from the UE 104 and is verified (either by a user or other service), the withdrawal code 124 may be activated for use. The process is described in more detail in FIGS. 2 and 3, below.

FIG. 2 describes a process 200 for receiving cryptocurrency using a cellular phone number. The process 200 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The process 200 commences at operation 202, wherein the UE 102 receives from a sender an amount of a cryptocurrency to send ("The Amount") and the recipient’s or receiver’s phone number.

The process 200 continues to operation 204, wherein the temporary (or intermediate) wallet 110 is generated. The temporary wallet accessible by the temporary wallet application 134 is generated, locally, on UE 102. In FIG. 1, the temporary wallet accessible by the temporary wallet application 134 is shown in the UE 104, although this is only to illustrate the use of the temporary wallet accessible by the temporary wallet application 134.

The process 200 continues to operation 206, wherein the new, intermediate private key 120 is generated. In some examples, the intermediate private key 120 is generated using cryptographically-secure RNG algorithms and various hashing algorithms including ASIC-resistant/GPU-resistant ones. In some examples, the intermediate private key 120, associated with the temporary wallet accessible by the temporary wallet application 134, is created by hashing a non-standard concatenation of bits which are split into 3 parts. In some examples, the first part are shared bits 122 (or Public Bits), which are stored on the currency transfer server 112. Access levels to the shared bits 122 can be established so that the shared bits 122 can only be accessed by users who have verified ownership of either a phone number associated with the UE 102 or a phone number associated with the receiver.

This verification is done by "logging in" to the app via phone number and entering a login code which is send via a communication system, such as a short messaging service (SMS) to said phone number. The second part of the intermediate private key 120 are deleted bits, which are not stored. A third part of the intermediate private key 120 are shared bits 122, which are encoded into an Alpha-numeric-symbolic "Withdrawal Code", which the Sender shares with the Recipient, ideally via Text Message. To generate the Private Key, in some examples, an ASIC resistant hash is performed on a concatenation of the Shares Bits and some of the Deleted Bits, with some public bits input to generate entropy. A hash is then performed, for example, SHA256, a concatenation of that ARGON2 hash and the personal identification number (PIN) and shared bits and deleted bits.

In some examples, the user wallet 110 is not active until the withdrawal code 124 (or other code) is transmitted from the user equipment 102 to the user equipment 104 using the cellular network 106 (or another communication network type). In this manner, no operations can be performed on the user wallet 110, such as the transfer of cryptocurrency, until on the user equipment 102 a user enters the withdrawal code 124. Therefore, even if a hacking operation were to be commenced on the user wallet 110, the operation would be abated because the user wallet 110 is not accessible.

The process 200 continues to operation 208, wherein the withdrawal code 124 is transmitted from the UE 102 to the UE 104 using the cellular phone number of the UE 104. The transfer may be made using various services, such as, but not limited to, messaging service 138 to the messaging service 140. In some examples, the messaging service 138 can include in the messages information about wallet addresses and payment receivable mechanisms on the contacts cards in a smartphone. For example, rather than requiring the use of a cellular number, a contact card may be used that includes the additional information. In some examples, a contact card is an electronic “card” stored on a device that includes a name, a cellular number, and other contact information associated with the contact. Other examples of messaging service 138 capabilities may include having 'Send Funds' and 'Request Funds' buttons built into native messaging apps and/or contacts apps on a smart phone. An additional capability of the messaging service 138 may also include making crypto addresses recognized and clickable such that they will launch a native wallet application on the phone when tapped on. For example, the withdrawal code 124 can comprise an active link that, when selected, can launch a native wallet application.

The process 200 continues to operation 210, wherein the UE 104 receives the withdrawal code 124.

The process 200 continues to operation 212, wherein the temporary wallet application 134 is accessed. A recipient can log in to the temporary wallet application 134 with the cellular phone number of the UE 104, which will show a pending deposit correlated with the cellular phone number of the UE 104. The temporary wallet application 134 will download the Public Bits of the private key of the Intermediary Wallet for which the pending deposit is in. the temporary wallet application 134 will then prompt the Recipient for their withdrawal code 124, which is decoded into the Shared Bits. Using the Shared Bits and Public Bits. the temporary wallet application 134 can then brute force the Private Key belonging to the Intermediary wallet in reasonable time.

In some examples, a hacker who only had access to the Public Bits but not the Shared Bits (withdrawal code) could not brute force the private key cost-effectively given the parameters selected by the algorithm based on the monetary value of the transaction size as well as the monetary cost associated with brute forcing of this nature. For example, if the transaction size is relatively low, the cost associated with the computing resources (and energy resources) will often be greater than the transaction size itself. The distributed nature of the system 100 of FIG. 1, whereby a central source of wallets to be hacked does not exist reduces the probability of wallet hacking. Further, because the system 100 of FIG. 1 is “active” only when a user device is connected to the Internet or some other communication network, a person trying to brute force the private key or otherwise access the private key will need to know when the user device is active on the network whereby a brute force operation can take place.

Once the private key is brute forced by the temporary wallet application 134, the recipient can then withdraw all of the funds from the intermediary wallet, using its Private Key to sign a transaction draining its balance to the Recipient's master wallet. In some examples, the temporary wallet generated by the temporary wallet application 134 can be used by the recipient as their master wallet, although more likely the temporary wallet generated by the temporary wallet application 134 will not be used as the master wallet for the recipient.

In some examples, a Sender can also regenerate the Intermediary Wallet's Private Key in this same fashion and drain the funds back to their original user wallet 110, thereby cancelling, or reclaiming the transaction. It should be noted, however, that this may be revoked server-side by denying their client access to the Public Bits, as could the Recipient's access, if needed. A variant of the algorithm may sometimes be used depending on what hashing algorithms are used and if they are configurable or not, in which there are no 'Deleted Bits' and instead the ASIC-resistant hashing parameters are adjusted such that the entropy and brute forcing time is about the same. In this scenario we may then just use the ASIC-resistant hash of the withdrawal code (salted with public bits) to encrypt (and decrypt) a random private key itself, rather than generating a private key via a hash of a concatenation containing that ASIC-resistant hash and other bits.

FIG. 3 depicts a component level view of the UE 102 for use with the systems and methods described herein. The UE 102 could be any device capable of providing the functionality associated with the systems and methods described herein. The UE 102 can comprise several components to execute the above-mentioned functions. The UE 102 may be comprised of hardware, software, or various combinations thereof. As discussed below, the UE 102 can comprise memory 302 including an operating system (OS) 304 and one or more standard applications 306. The standard applications 306 may include applications that provide for the transfer of cryptocurrency, such as the coin transfer application 108.

The UE 102 can also comprise one or more processors 310 and one or more of removable storage 312, non-removable storage 314, transceiver(s) 316, output device(s) 318, and input device(s) 320. In various implementations, the memory 302 can be volatile (such as random-access memory (RAM)), non-volatile (such as read only memory (ROM), flash memory, etc.), or some combination of the two. The memory 302 can include data pertaining to operational pressure ranges of the switching rails 140A and 140B, and other information, and can be stored on a remote server or a cloud of servers accessible by the UE 102.

The memory 302 can also include the OS 304. The OS 304 varies depending on the manufacturer of the UE 102. The OS 304 contains the modules and software that support basic functions of the UE 102, such as scheduling tasks, executing applications, and controlling peripherals. The OS 304 can also enable the UE 102 to send and retrieve other data and perform other functions, such as transmitting control signals using the transceivers 316 and/or output devices 318 and receiving switching conditions using the input devices 320.

The UE 102 can also comprise one or more processors 310. In some implementations, the processor(s) 310 can be one or more central processing units (CPUs), graphics processing units (GPUs), both CPU and GPU, or any other combinations and numbers of processing units. The UE 102 may also include additional data storage devices (removable and/or non-removable) such as, for example, magnetic disks, optical disks, or tape. Such additional storage is illustrated in FIG. 3 by removable storage 312 and non-removable storage 314.

Non-transitory computer-readable media may include volatile and nonvolatile, removable and non-removable tangible, physical media implemented in technology for storage of information, such as computer readable instructions, data structures, program modules, or other data. The memory 302, removable storage 312, and non-removable storage 314 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the UE 102. Any such non-transitory computer-readable media may be part of the UE 102 or may be a separate database, databank, remote server, or cloud-based server.

In some implementations, the transceiver(s) 316 include any transceivers known in the art. In some examples, the transceiver(s) 316 can include wireless modem(s) to facilitate wireless connectivity with other components (e.g., between the UE 102 and a wireless modem that is a gateway to the Internet), the Internet, and/or an intranet. Specifically, the transceiver(s) 316 can include one or more transceivers that can enable the UE 102 to send and receive data. Thus, the transceiver(s) 316 can include multiple single-channel transceivers or a multi-frequency, multi-channel transceiver to enable the UE 102 to send and receive video calls, audio calls, messaging, etc. The transceiver(s) 316 can enable the UE 102 to connect to multiple networks including, but not limited to 2G, 3G, 4G, 5G, and Wi-Fi networks. The transceiver(s) 316 can also include one or more transceivers to enable the UE 102 to connect to future (e.g., 6G) networks, Internet-of-Things (IoT), machine-to machine (M2M), and other current and future networks.

The transceiver(s) 316 may also include one or more radio transceivers that perform the function of transmitting and receiving radio frequency communications via an antenna (e.g., Wi-Fi or Bluetooth^{®}). In other examples, the transceiver(s) 316 may include wired communication components, such as a wired modem or Ethernet port, for communicating via one or more wired networks. The transceiver(s) 316 can enable the UE 102 to facilitate audio and video calls, download files, access web applications, and provide other communications associated with the systems and methods, described above.

In some implementations, the output device(s) 318 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 318 can also include speakers, or similar devices, to play sounds or ringtones when an audio call or video call is received. Output device(s) 318 can also include ports for one or more peripheral devices, such as headphones, peripheral speakers, or a peripheral display.

In various implementations, input device(s) 320 include any input devices known in the art. For example, the input device(s) 320 may include a camera, a microphone, or a keyboard/keypad. The input device(s) 320 can include a touch-sensitive display or a keyboard to enable users to enter data and make requests and receive responses via web applications (e.g., in a web browser), make audio and video calls, and use the standard applications 306, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 320 and an output device 318.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A device for sending cryptocurrency to a recipient, the device comprising:
a memory storing computer-executable instructions; and
a processor in communication with the memory, the computer-executable instructions causing the processor to perform acts comprising:
receiving, from a contact card of a recipient to receive cryptocurrency, the contact card comprising a cellular phone number associated with a device used by the recipient to receive the cryptocurrency;
transmitting a notice to the cellular phone number associated with the contact card that cryptocurrency is available for the recipient; and
receiving a second notice that the recipient has accepted a delivery of the cryptocurrency.

2. The device of claim 1, wherein the notice to the cellular phone number comprises a withdrawal code.

3. The device of claim 1, wherein the computer-executable instructions further comprise computer-executable instructions that, when executed by the processor, cause the processor to perform acts comprising:
establishing a temporary wallet for receiving a monetary deposit of the cryptocurrency intended for the receiver; and
generating a withdrawal code.

4. The device of claim 3, wherein the computer-executable instructions further comprise computer-executable instructions that, when executed by the processor, cause the processor to perform acts comprising generating a private key associated with the temporary wallet by hashing a plurality of local bits, a plurality of memorized bits, a plurality of deleted bits, and a plurality of shared bits.

5. The device of claim 3, wherein the computer-executable instructions further comprise computer-executable instructions that, when executed by the processor, cause the processor to perform acts comprising recovering a private key by:
securely storing a plurality of local bits on a user device associated with a sender;
encoding a plurality of memorized bits into a personal identification number (PIN);
deleting a plurality of deleted bits;
storing a plurality of shared bits on a third-party’s server so that the plurality of shared bits can only be accessed by the sender with authorized access; and
receiving a request to generate a second private key using the plurality of local bits, the plurality of memorized bits, the PIN, and the plurality of shared bits.

6. A method of providing purchases for applications, the method comprising:
hashing at least one private key to generate a plurality addresses;
associating each of a plurality of addresses to a plurality of cryptocurrency wallets, whereby each address of the plurality of addresses is associated with one cryptocurrency wallet of the plurality of cryptocurrency wallets;
receiving a notice from an application, the notice comprising a purchase price and a unique identifier associated with a user;
associating the user to one of the plurality of cryptocurrency wallets;
receiving a payment from a user into the one of the plurality of cryptocurrency wallets;
notifying the application that the user has paid an amount required;
storing the payment until a predetermined time;
releasing the payment to the application at an expiration of the predetermined time; and
releasing the one of the plurality of cryptocurrency wallets for use in another transaction by another user.
